(19) United States
(12) Patent Application Publication
(10) Pub. No.: US 2025/0158133 A1
(43) Pub. Date: May 15, 2025

(54) ANODE-FREE CELL WITH CONTINUOUS STACKING FOLD

(71) Applicant: Our Next Energy, Inc., Novi, MI (US)

(72) Inventor: Qingcheng Zeng, Novi, MI (US)

(21) Appl. No.: 18/943,102

(22) Filed: Nov. 11, 2024

Related U.S. Application Data
(60) Provisional application No. 63/597,927, filed on Nov. 10, 2023.

(51) Int. Cl. H01M 10/0585; H01M 4/02; H01M 4/66; H01M 10/04; H01M 10/052; H01M 50/434; H01M 50/449

(52) U.S. Cl. CPC H01M 10/0585; H01M 4/661; H01M 10/0454; H01M 10/052; H01M 50/434; H01M 50/449; H01M 2004/021

(57) ABSTRACT

An anode-free cell including a housing and a plurality of cathode layers each cathode layer includes a cathode current collector disposed between two cathode active material layers. The anode-free cell also includes a pair of separators, and an anode current collector laminated in between the pair of separators to form a continuous laminated separator-current collector-separator layer. The continuous laminated separator-current collector-separator layer is positioned in between adjacent cathode layers of the plurality of cathode layers in a continuous stacking fold.

### BACKGROUND

### Technical Field

The present disclosure generally relates to cell stacking and more particularly to Z-stacking of an anode-free cell based on a continuous anode current collector sheet.

### Description of the Related Art

Energy storage devices such as batteries with high energy density and power density, long cycle life, adequate safety and low cost are in high demand to supply power to electronic devices such as electric vehicles (EVs) and smart grid energy storage systems. A typical Li-ion battery is made up of many cells, each of which is made up of an anode current collector, anode, separator, cathode, and cathode current collector. Each of these components is submerged in an electrolyte. Commercial electronics can employ Li-ion batteries in a number of configurations wherein Li+ ions are released from the cathode during a charge procedure, diffuse through the separator, and then intercalate into the anode material. The process reverses during the discharge procedure.

### BRIEF SUMMARY

According to an embodiment of the present invention, an anode-free cell is disclosed. The anode-free cell includes a housing, and a plurality of cathode layers each cathode layer including a cathode current collector disposed between two cathode active material layers. The anode-free cell also includes a pair of separators, and an anode current collector laminated in between the pair of separators to form a continuous laminated separator-current collector-separator layer. The continuous laminated separator-current collector-separator layer is positioned in between adjacent cathode layers of the plurality of cathode layers in a continuous stacking fold.

In an embodiment, the pair of separators are each coated with ceramic.

In an embodiment, an adhesive pre-coating is placed between the pair of separators and a corresponding anode current collector.

According to an embodiment of the present invention, a method is disclosed. The method includes manufacturing an anode free cell by providing a housing for the anode free sell, the housing extending along a first axis (X-axis) to define a width, a second axis (Y-axis) orthogonal to the first axis to define a length, and a third axis (Z-axis) orthogonal to the first and second axes to define a thickness. For each cathode layer of a plurality of cathode layers a cathode current collector is disposed between two cathode active material layers. In the method, a pair of separators are received, and an anode current collector is laminated in between the pair of separators to form a continuous laminated separator-current collector-separator layer. The continuous laminated separator-current collector-separator layer is then used to form a z-fold by disposing the continuous laminated separator-current collector-separator layer in between adjacent cathodes layers of the plurality of cathode layers. Advantageously, using the z-fold enables the continuous laminated separator-current collector-separator layer to be cut once for every cell, thus reducing a handling time of the anode current collector, and alleviating otherwise costly damage that may be applied thereto.

### BRIEF DESCRIPTION OF THE DRAWINGS

To easily identify the discussion of any particular element or act, the most significant digit or digits in a reference number refer to the figure number in which that element is first introduced.

FIG. 1A depicts a cross-section of at least a portion of an anode-free cell in accordance with an illustrative embodiment.

FIG. 1B depicts a cross-section of at least a portion of an anode-free cell after a charging operation in accordance with an illustrative embodiment.

FIG. 1C depicts a top view of a housing and electrode tabs in accordance with an illustrative embodiment.

FIG. 2 depicts a cross section of an anode-free cell with a continuous stacking fold in accordance with an illustrative embodiment.

FIG. 3 depicts a continuous roll-to-roll lamination in accordance with an illustrative embodiment.

FIG. 4 depicts a continuous stacking in accordance with an illustrative embodiment.

FIG. 5 depicts a continuous stacking routine 500 in accordance with one embodiment.

FIG. 6 depicts a functional block diagram of a computer hardware platform in accordance with an illustrative embodiment.

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, and/or components have been described at a relatively high-level, without detail, to avoid unnecessarily obscuring aspects of the present teachings.

In one aspect, spatially related terminology such as “front,” “back,” “top,” “bottom,” “beneath,” “below,” “lower,” above,” “upper,” “side,” “left,” “right,” and the like, is used with reference to the orientation of the Figures being described. Since components of embodiments of the disclosure can be positioned in a number of different orientations, the directional terminology is used for purposes of illustration and is in no way limiting. Thus, it will be understood that the spatially relative terminology is intended to encompass different orientations of the device in use or operation in addition to the orientation depicted in the figures. For example, if the device in the figures is turned over, elements described as “below”, or “beneath” other elements or features would then be oriented “above” the other elements or features. Thus, for example, the term “below” can encompass both an orientation that is above, as well as below. The device may be otherwise oriented (rotated 90 degrees or viewed or referenced at other orientations) and the spatially relative descriptors used herein should be interpreted accordingly.

As used herein, the terms “lateral” and “horizontal” describe an orientation parallel to a first surface of a cell. As used herein, the term “vertical” describes an orientation that is arranged perpendicular to the first surface of a cell.

As used herein, the terms “coupled” and/or “electrically coupled” are not meant to mean that the elements must be directly coupled together—intervening elements may be provided between the “coupled” or “electrically coupled” elements. In contrast, if an element is referred to as being “directly connected” or “directly coupled” to another element, there are no intervening elements present. The term “electrically connected” refers to a low-ohmic electric connection between the elements electrically connected together.

Although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

Example embodiments are described herein with reference to cross-sectional illustrations that are schematic illustrations of idealized or simplified embodiments (and intermediate structures). As such, variations from the shapes of the illustrations as a result, for example, of manufacturing techniques and/or tolerances, may be expected. Thus, the regions illustrated in the figures are schematic in nature and their shapes do not necessarily illustrate the actual shape of a region of a device and do not limit the scope.

It is to be understood that other embodiments may be used, and structural or logical changes may be made without departing from the spirit and scope defined by the claims. The description of the embodiments is not limiting. In particular, elements of the embodiments described hereinafter may be combined with elements of different embodiments.

For the sake of brevity, conventional techniques related to battery cells and their fabrication may or may not be described in detail herein. Moreover, the various tasks and process steps described herein can be incorporated into a more comprehensive procedure or process having additional steps or functionality not described in detail herein.

Turning now to an overview of technologies that generally relate to the present teachings, anode-free, anode-less or initial anode-free cells, are a type of lithium metal cells. Lithium-metal cells may work in a similar fashion to lithium-ion cells but instead of using a graphite anode host material, may use a high-energy lithium metal. Anode-free lithium (Li) metal cells are lithium metal cells that may be manufactured without a lithium metal anode, or any other anode host material, such as graphite, titanate, iron-oxide, silicon, silicon-oxide. In some embodiments discussed herein, the anode-free cells may be cells wherein a lithium anode is subsequently generated, after manufacturing, inside the cell during operation as the cell changes under an external influence when the cell is charged the first time. However, in other embodiments discussed herein, anode-free cells may be cells in which all lithium may be removed from the cathode when the cell is fully charged. Lithium ions, provided by the cathode active material, are deposited as metallic lithium onto a metal substrate, such as copper or nickel foil or mesh to create the working cell. Though anode-free, anode-less or initial anode-free cells are discussed herein, these are not meant to be limiting as the methods and systems may also equally apply to lithium metal cells in general. Lithium metal and anode-free lithium cells may have certain advantages over traditional lithium ion, as they are more energy dense. Anode-free cells may also be less expensive and easier to assemble due to their lack of anode coating and ability to utilize Li-metal's full capacity.

The illustrative embodiments recognize that cells may be manufactured by a stacking process wherein cathode and anode sheets of the cell may be dimensioned into a predetermined size, and the cathode sheets, separator and anode sheets may be picked and placed, by a suction means, for example, to be stacked into units which are then combined together to generate a final single cell. However, picking and placing the sheets can be significantly difficult to perform as the sheets may be thin thus causing deformation, damaging, and improper handling of the sheets. For example, for a pick and place process of a 4-micron to 10-micron thick foil, custom pick and place tooling on the scale of +/−1 μm may be appropriate to prevent damage to the foil but this may be significantly difficult to achieve. Further, cutting of the sheets into single sheets may be difficult to manage as blades used may soon wear out. Laser cutting can result in 70-90 percent reflection from the copper foil, thus requiring high powered lasers, and custom tools for die cutting the sheets during manufacturing.

Aspects described herein provide an anode-free cell and a continuous stacking fold thereof. The anode-free cell includes a plurality of cathode layers each cathode layer comprising a cathode current collector disposed between two cathode active material layers. The anode-free cell additionally includes a pair of separators; and an anode current collector laminated in between the pair of separators to form a continuous laminated separator-current collector-separator layer. The continuous laminated separator-current collector-separator layer is disposed in between adjacent cathode layers of the plurality of cathode layers in a continuous stacking fold. Aspects described herein also include a method for manufacturing the anode-free cell.

### Example Architecture

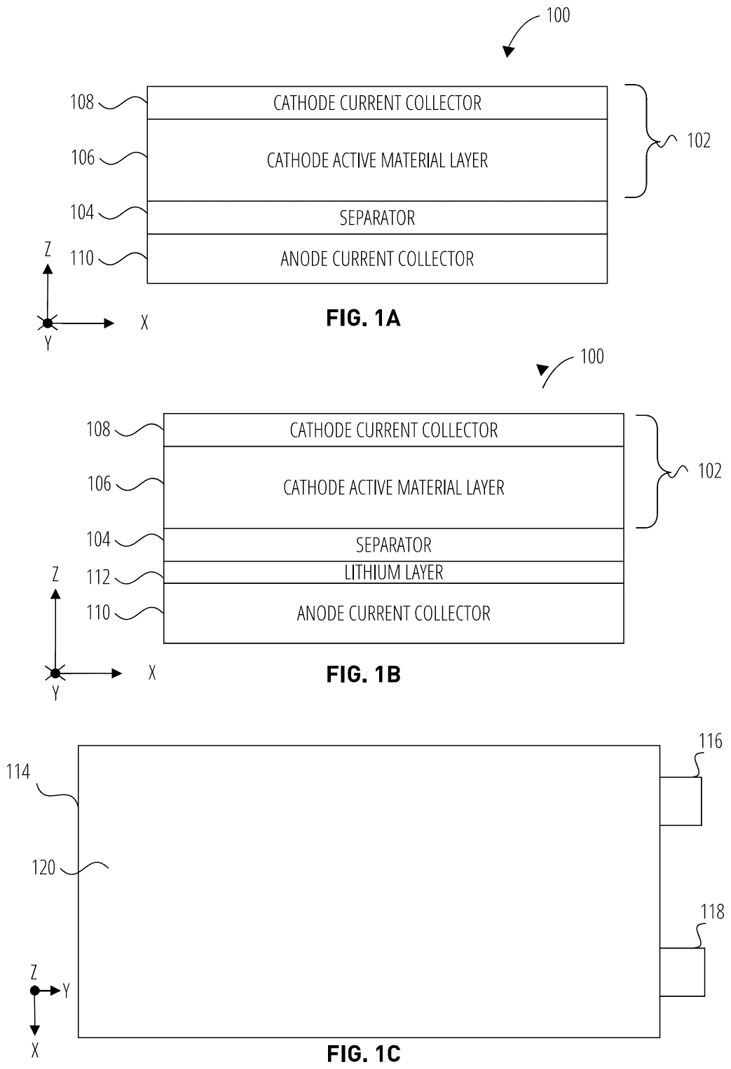

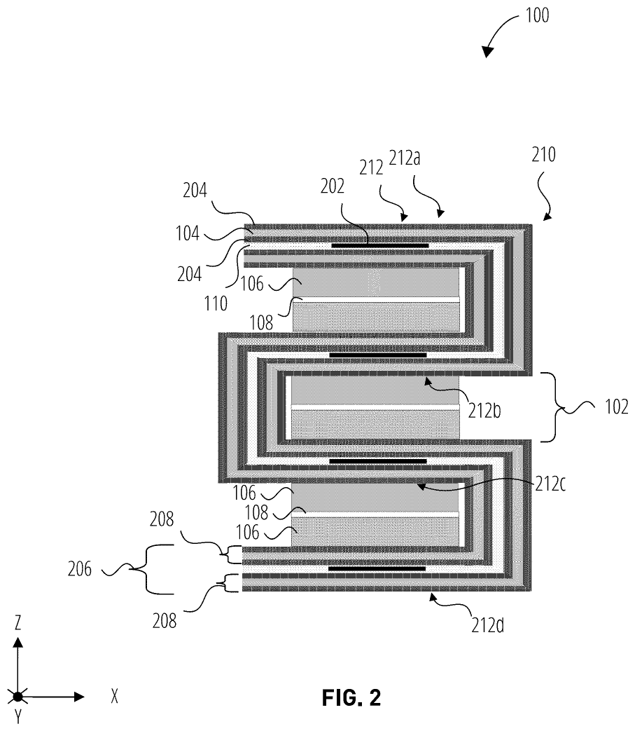

Turning to FIG. 1A and FIG. 1B, a general structure of at least a portion of the anode-free cell 100 is shown. The anode-free cell 100 comprises a cathode layer 102, a separator 104, a cathode current collector 108, and an anode current collector 110. The cathode current collector 108 may comprise at least a conductive film that further comprises, for example, an aluminum foil. Other materials of conductive foils are possible. The cathode active material layer 106 of FIG. 1A and FIG. 1B may comprise a first surface in contact with the cathode current collector 108, and an opposite surface that may be in contact with the separator 104. The separator may be in some cases a coated separator 208 as shown in FIG. 2. The separator may prevent a direct electrical connection between the cathode layer 102 and the anode current collector 110. In this configuration, prior to a first charging cycle, the anode-free cell 100 does not have an anode or lithium layer 112. The separator 104 may have characteristics that further inhibit dendrite growth.

The separator 104 may have a first surface in contact with the cathode layer 102 and a second surface opposite the first surface in contact the anode current collector 110. In some embodiments, the anode current collector 110 comprises a conductive foil, such as a copper foil. As shown in FIG. 1B, lithium ions, provided by the active cathode material, may be deposited as metallic lithium (lithium layer 112) onto the anode current collector 110. An electrolyte of the anode-free cell may comprise lithium difluoro(oxalato)borate, lithium tetrafluoroborate and a solvent component. However, other electrolytes may be used. Further, the cathode may be, for example, Lithium Nickel Manganese Cobalt Oxides (NMC)—Li(NixMnyCoz)O2 where 0≤x, y, z≤1, Lithium Manganese Oxide (LMO)—LiMn2O4, Lithium Manganese Iron Phosphate (LMFP)—LiMnxFeyPO4 where 0<x, y<1, Lithium Iron Phosphate (LFP)—LiFePO4, or Lithium Cobalt Oxide (LCO)—LiCoO2.

FIG. 1C illustrates a top view of a housing 114 or pouch of a cell described herein. The housing 114 comprises a large wall surface 120 that is parallel to the YX plane, the YX plane being a two-dimensional plane in three-dimensional space that is perpendicular to the Z-axis and more specifically a two-dimensional plane in three-dimensional space that is perpendicular to a surface of the cell through which the positive tab 118 and/or negative tab 116 of the cell passes from inside the housing 114 to be exposed outside the housing 114.

FIG. 2 illustrates a cross section of an anode-free cell 100 in accordance with an illustrative embodiment. The anode-free cell 100 comprises a housing 114 extending along a first axis (X-axis) to define a width, a second axis (Y-axis) orthogonal to the first axis to define a length, and a third axis (Z-axis) orthogonal to the first and second axes to define a thickness. The anode-free cell 100 comprises a plurality of cathode layers 102 that are separate from each other and each cathode layer 102 comprising a cathode current collector 108 disposed between two cathode active material layers 106. The anode-free cell 100 further comprises a pair of separators. The separators 104 may be coated with a coating 204 to form the coated separator 208. In as aspect, the coating 204 is a ceramic coating.

The anode-free cell 100 further comprises an anode current collector 110 which is disposed between the pair of separators to form a continuous laminated separator-current collector-separator layer 206. The continuous laminated separator-current collector-separator layer 206 is a “one-piece” structure that is continuous and formed by laminating a single anode current collector sheet with a coated separator 208 on each side. The continuous laminated separator-current collector-separator layer 206 is disposed in between adjacent cathode layers 102 of the plurality of cathode layers in a continuous stacking fold 210 that is continuously stacked in the Z-axis direction as described herein.

In an aspect, the anode current collector 110 is a copper foil that is laminated to the ceramic coated separator on both sides of the copper foil. The lamination of the ceramic coated separator-copper foil-ceramic coated separator may provide a three-piece component that acts as one piece in folding process to ensure the maintenance of desired folding structure. Further, a thickness of the anode current collector is from 4-10 μm. Thus, by the use of a continuous stacking of the continuous laminated separator-current collector-separator layer 206 in the Z-axis direction as opposed to a pick and place process, damage to the foil is avoided, and the foil can be cut once during, for example, the lamination process for every cell. Using a continuous sheet in a z-fold/stacking fold thus, alleviates excessive handling of the foil and increases the life of the cell by reducing the possibility of copper wrinkling.

In an aspect, the continuous stacking fold 210 comprises a plurality of contiguous sections 212 such as the first contiguous section 212a, the second contiguous section 212b, the third contiguous section 212c, and the fourth contiguous section 212d. The contiguous sections 212 make up the continuous laminated separator-current collector-separator layer 206 and are formed as a result of the bending of the continuous laminated separator-current collector-separator layer 206 in the Z-axis direction. Each contiguous section 212 that is not at the outermost edge of the continuous laminated separator-current collector-separator layer 206 is disposed in between two adjacent cathode layers 102. In an aspect anode-free cell 100 comprises at least 3 contiguous sections, or at least 5 contiguous sections, or at least 100 contiguous sections, or at least 1000 contiguous sections. Each contiguous section 212 may also comprise a tab 202. More generally, the continuous laminated separator-current collector-separator layer 206 comprises a plurality of tabs 202.

To make the pair of separators or pair of coated separators stick to the anode current collector, an adhesive pre-coating (not shown) may be applied in between the anode current collectors and the separators or coated separators.

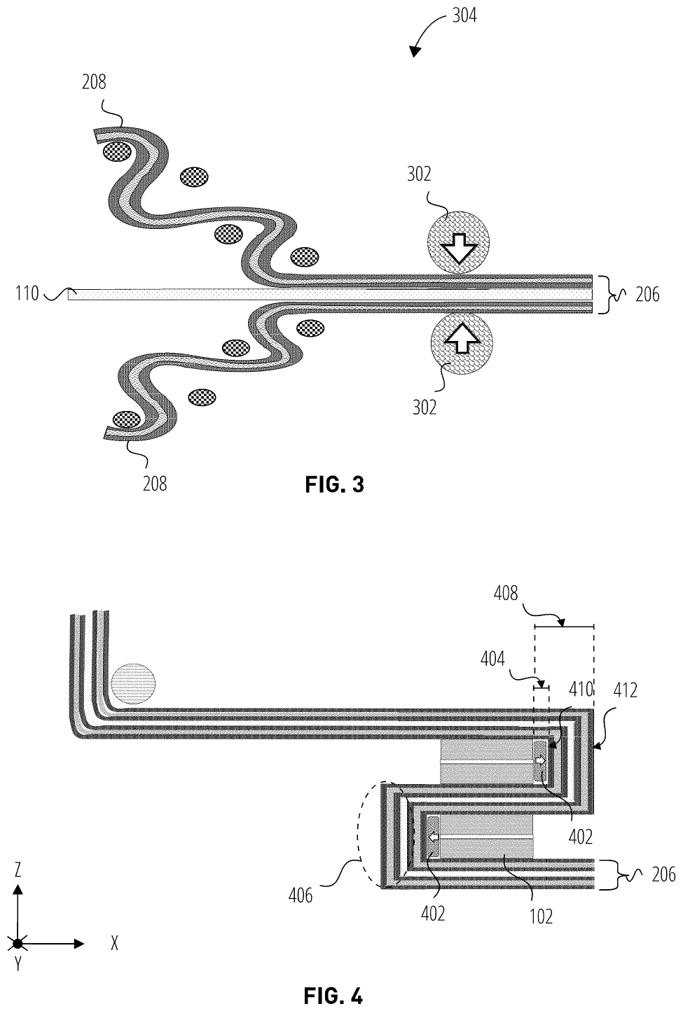

FIG. 3 depicts a continuous roll-to-roll lamination in accordance with an illustrative embodiment. The continuous roll-to-roll lamination is performed with a lamination system 304 which comprises at least a roll press 302.

Upon receiving a continuous sheet of the anode current collector 110 and a pair of the continuous separators or coated separators 208, the lamination system 304 laminates the anode current collector in between the pair of separators using the roll press 302 to form the continuous laminated separator-current collector-separator layer 206.

FIG. 4 illustrates continuous stacking of the continuous laminated separator-current collector-separator layer 206 in accordance with an illustrative embodiment. As shown in FIG. 4, the continuous laminated separator-current collector-separator layer 206 is placed in between the cathode layers 102 in the Z-axis direction. The placement generates a bend 406, a shape of which may be dependent on a shape of the bend forming finger 402 used to generate the bend. In an aspect herein the bend 406 is a natural bend and thus, curved.

Disposing the continuous laminated separator-current collector-separator layer 206 in between adjacent cathode layers may comprise dimensioning the bend forming finger 402 and a clearance 404, in the X-axis direction, between the cathode layer 102 and a corresponding first edge 410 of the continuous laminated separator-current collector-separator layer 206 such that the bend forming finger 402 when placed in the clearance 404 forms a natural bend. A dimension of the clearance 404 and of the distance 408 may be selected to prevent pinching of the cathode by the continuous laminated separator-current collector-separator layer 206. In an example, an ideal distance 408 in the X-axis direction between the cathode layer 102 and a second edge 412 (farthest edge away from the bend forming finger 402) of the continuous laminated separator-current collector-separator layer 206 is from 0.5 mm to 2 mm. This distance 408 may be selected to maintain an ideal capacity of the cell. Thus, based on the distance 408, configured to maintain cell capacity, and the clearance 404, configured to prevent pinching of the cathode, the bend forming finger 402 is dimensioned appropriately to alleviate damaging of the cathode or continuous laminated separator-current collector-separator layer 206 and to form a bend 406 that does not crack or delaminate. Ceramic coating on the cathode typically tends to crack when bent by an angle of 180°. By removing material on the bending line, cracking may be avoided. Further, the bend forming finger 402 may comprise a radius of 0.2-1 mm which may alleviate cracking or delamination. The distance 408 may in some embodiments reduce the cathode/anode overhand from ±1.5 mm to ±0.3 mm, which may increase the cell stack size. Avoiding interference between the cathode layer 102 and the anode current collector 110 during normal use of the cell where bending and movement can otherwise cause them to come into contact may alleviate safety issues.

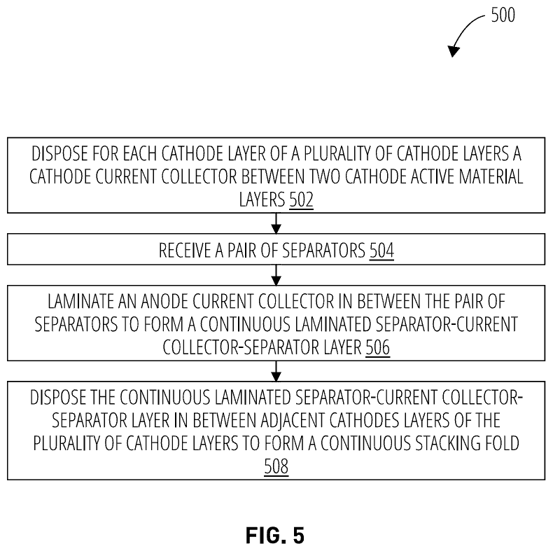

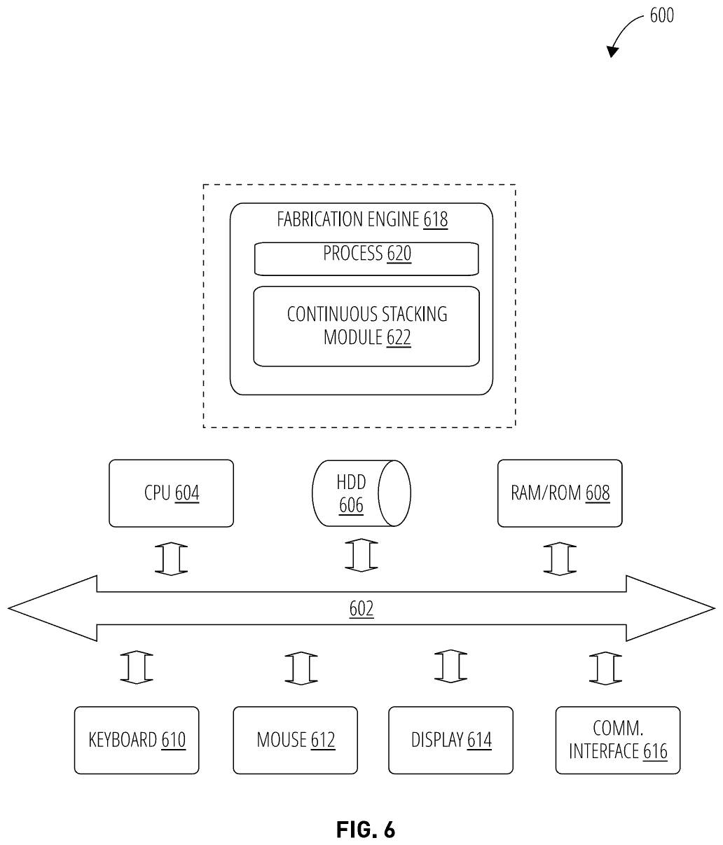

FIG. 5 shows a continuous stacking routine 500 in accordance with an embodiment. The routine can be performed with a fabrication engine such as the fabrication engine 618 of FIG. 6. In block 502, the fabrication engine 618 disposes for each cathode layer of a plurality of cathode layers a cathode current collector between two cathode active material layers. In block 504, fabrication engine 618 receives a pair of separators. In block 506, fabrication engine 618 laminates an anode current collector in between the pair of separators to form a continuous laminated separator-current collector-separator layer. In block 508, fabrication engine 618 disposes the continuous laminated separator-current collector-separator layer in between adjacent cathodes layers of the plurality of cathode layers to form at least a portion of an anode-free cells including a continuous stacking fold 210 comprising a plurality of bends 406 wherein the plurality of bends 406 are crack-free and delamination-free. The resulting structure is then placed in a housing, for example a pouch, to generate the anode-free cell 100.

In an aspect of the routine 500, a single sheet of continuous laminated separator-current collector-separator layer is used for the cell by cutting the continuous laminated separator-current collector-separator layer once or a minimal number of times (e.g., twice) in the continuous roll-to-roll lamination process.

In another aspect of the routine 500, a plurality of tabs 202 are formed on the anode current collector prior to the lamination process. This may be performed by any number of processes such as by laser notching.

### Example Computer Platform

As discussed above, functions relating to methods and systems for continuous stacking of at least some components of an anode-free cell can use of one or more computing devices connected for data communication via wireless or wired communication. FIG. 6 is a functional block diagram illustration of a computer hardware platform that can be used to control various aspects of a suitable computing environment in which the process discussed herein can be controlled. While a single computing device is illustrated for simplicity, it will be understood that a combination of additional computing devices, program modules, and/or combination of hardware and software can be used as well. The computer platform 600 may include a central processing unit (CPU) 604, a hard disk drive (HDD) 606, random access memory (RAM) and/or read only memory (ROM) 608, a keyboard 610, a mouse 612, a display 614, and a communication interface 616, which are connected to a system bus 602.

In one embodiment, the hard disk drive (HDD) 606, has capabilities that include storing a program that can execute various processes, such as processes of the fabrication engine 618, in a manner described herein. The fabrication engine 618 may have various modules configured to perform different functions. For example, there may be a process module 620 configured to control the different manufacturing processes discussed herein and others. There may be a continuous stacking module 622 operable to provide an appropriate dimensioning, mechanical positioning, lamination, and in general, assembly of a cell.

For the sake of brevity, conventional techniques related to making and using aspects of the disclosure may or may not be described in detail herein. In particular, various aspects of manufacturing and computing systems and specific programs to implement the various technical features described herein may be well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram, or the steps (or operations) described therein without departing from the spirit of the disclosure. For instance, the actions can be performed in a differing order or actions can be added, deleted, or modified.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. An anode-free cell comprising:
a housing having a width along a first axis (X-axis), a length along a second axis (Y-axis) orthogonal to the first axis, and a thickness along a third axis (Z-axis) orthogonal to the first and second axes;
a plurality of cathode layers, each cathode layer of the plurality of cathode layers comprising a cathode current collector disposed between two cathode active material layers;
a pair of separators; and
an anode current collector laminated between the pair of separators to form a continuous laminated separator-current collector-separator layer,
wherein the continuous laminated separator-current collector-separator layer is disposed between adjacent cathode layers of the plurality of cathode layers in a continuous stacking fold.

2. The anode-free cell of claim 1, wherein the anode current collector is a copper foil.

3. The anode-free cell of claim 1, wherein the pair of separators are coated with a first material.

4. The anode-free cell of claim 3, wherein the first material is a ceramic.

5. The anode-free cell of claim 1, wherein a thickness of the anode current collector is 4-10 μm.

6. The anode-free cell of claim 1, wherein:
the continuous stacking fold comprises a plurality of contiguous sections;
each of a number of the plurality of contiguous sections are disposed between two adjacent cathode layers.

7. The anode-free cell of claim 6, wherein the plurality of contiguous sections comprises at least 3 contiguous sections.

8. The anode-free cell of claim 7, wherein the plurality of contiguous sections comprises at least 5 contiguous sections.

9. The anode-free cell of claim 1, further comprising an adhesive coating between the anode current collectors and the pair of separators.

10. The anode-free cell of claim 1, wherein the continuous laminated separator-current collector-separator layer comprises a plurality of tabs.

11. A method of manufacturing an anode free cell comprising:
providing a housing for the anode free sell, the housing having a width along a first axis (X-axis), a length along a second axis (Y-axis) orthogonal to the first axis, and a thickness along a third axis (Z-axis) orthogonal to the first and second axes;
for each cathode layer of a plurality of cathode layers, disposing a cathode current collector between two cathode active material layers;
laminating an anode current collector between a pair of separators to form a continuous laminated separator-current collector-separator layer; and
disposing the continuous laminated separator-current collector-separator layer in between adjacent cathodes layers of the plurality of cathode layers to form a continuous stacking fold.

12. The method of claim 11, wherein the laminating is performed in a continuous roll-to-roll lamination process.

13. The method of claim 12, wherein a single sheet of continuous laminated separator-current collector-separator layer is used for the cell by cutting the continuous laminated separator-current collector-separator layer once in the continuous roll-to-roll lamination process.

14. The method of claim 11, further comprising:
generating a plurality of tabs on the anode current collector prior to the laminating.

15. The method of claim 11, wherein the plurality of tabs are generated by laser notching.

16. The method of claim 11, further comprising:
pre-coating the anode current collector to increase adhesion of the pair of separators to the anode current collector upon the laminating.

17. The method of claim 11, wherein the disposing the continuous laminated separator-current collector-separator layer in between adjacent cathode layers comprises dimensioning a bend forming finger and a clearance between the cathode layer and a corresponding edge of the continuous laminated separator-current collector-separator layer such that the bend forming finger placed in the clearance forms a natural bend.

18. The method of claim 17, wherein a radius of the bend forming finger is 0.2-1 mm.

19. The method of claim 17, wherein a distance between the cathode layer and a far end of the continuous laminated separator-current collector-separator layer in the X-axis is from 0.5 mm to 2 mm.

20. The method of claim 17, wherein the natural bend is crack-free and delamination-free.
